(19) United States
(12) Patent Application Publication
(10) Pub. No.: US 2003/0200629 A1
(43) Pub. Date: Oct. 30, 2003

(54) Cam hinge

(76) Inventor: Adam Dewitt Schefter, Gorrie (CA)

Correspondence Address: ADAM SCHEFTER, RR# 1, Gorrie, ON, N0G 1X0, CA

(21) Appl. No.: 10/335,529

(22) Filed: Jan. 3, 2003

(30) Foreign Application Priority Data
Apr. 26, 2002 (CA) 2381654

(51) Int. Cl. E05D 3/06

(52) U.S. Cl. 16/366

(57) ABSTRACT

A Cam Hinge is a hinge mechanism that connects a Wing Framework to a horizontal Main Framework in a perpendicular orientation, and allows the Wing Framework to fold down and form a single close fitting platform in one plane. Such a hinge is generally used in portable staging and or folding wing systems. The Wing Framework folds down to a horizontal position and is supported by a leg in contact with the ground on the outside edge of the Wing Framework. At this point the cam lever is unlocked and rotated approximately 190 degrees to the final position creating a close fitting platform in one plane.

### CROSS-REFERENCE TO RELATED APPLICATIONS

Prior application for the invention above, entitled “cam hinge”, has been filed in Canada. The application number is 2,381,654 with a filing date of Apr. 26, 2002.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

“This invention relates to a portable stage platform that is used for singing, drama or band performances.”

“It is common for a portable trailer unit style of stage platform to be designed with folding wings for transportation. These units have attached wings to the main frame with a Single Pivot Hinge mechanism. This style of hinge mechanism is inefficient because the wings, when folded into the horizontal position, create space between the edge of the main floor and the edge of the wing floor. This space filled with a spacer creates a weak point, and requires extra labor to install during setup and removal. A second style of stage platform is designed with uniform small platforms that are attached and leveled individually. These systems are very labor intensive to setup and remove.”

### BRIEF SUMMARY OF THE INVENTION

“I have found that these problems can be overcome by creating a hinge mechanism that pivots first and then rotates into place. This allows two surfaces to form a close fitting platform in one plane, which requires less effort to setup and remove the stage platform. The Wing Framework folds down to a horizontal position and is supported by a leg in contact with the ground on the outside edge of the Wing Framework. At this point the cam lever is unlocked and rotated approximately 190 degrees to the final position creating a close fitting platform in one plane.”

### BRIEF DESCRIPTION OF THE SEVERAL VIEWS OF THE DRAWING

“In drawings which illustrate embodiments of the invention,

FIG. 1 is a side view of the Cam Hinge mechanism folded up,

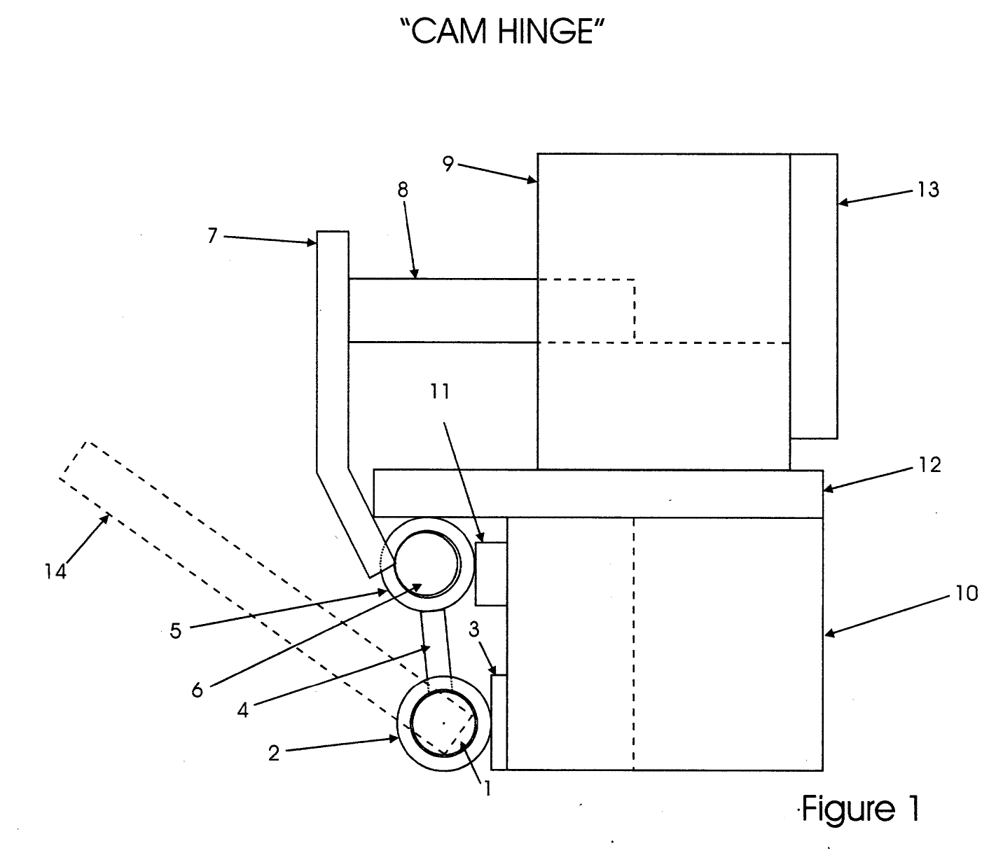

FIG. 2 is a side view of the Cam Hinge mechanism folded down,

FIG. 3 is a front view of the Cam Hinge mechanism folded up.”

### DETAILED DESCRIPTION OF THE INVENTION

“The Cam Hinge mechanism illustrated comprises of a Single Pivot Point 6, and Single Cam Pivot Point 1. The Cam Hinge mechanism is supported by the Main Framework 10 to which it is welded.”

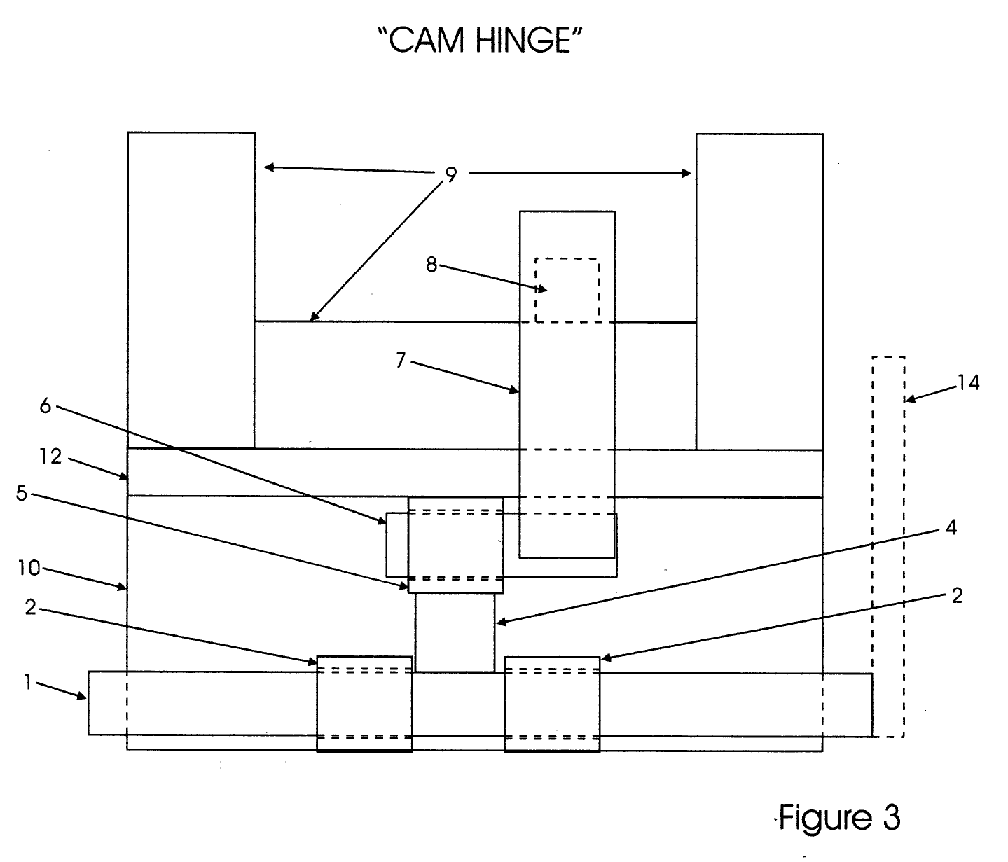

“The Single Cam Pivot Point assembly is composed of five parts. The Main Shaft 1, which sits parallel to and runs the full length of Main Framework 10, is best viewed in FIG. 3. The Main Shaft 1 is supported and held in place by Bushings 2 and is spaced out from Main Framework 10 with Spacers 3 for ease of welding. Welded perpendicular and centered from Main Shaft 1 is Spacer 4 so that Bushing 5 can be welded at the opposite end of Spacer 4 to create the cam movement.”

“The Single Pivot Point assembly is composed of three parts and is supported by Bushing 5. The Single Pivot Point Shaft 6 protrudes through Bushing 5 which is best viewed in FIG. 3. Welded to the end of Shaft 6 is the Support Arm 7 which sits in a vertical position when Cam Hinge mechanism is folded up. Support arm 7 is angled so as to clear the protrusion of Main Floor 12. Support Arm 7 is attached to the Wing Framework 9 by Support Piece 8. Support Piece 8 at the opposite end and in a perpendicular position from Support Arm 7 where Shaft 6 is located. Support piece 8 is attached to Wing Framework 9 with a weld to create the complete Cam Hinge mechanism.”

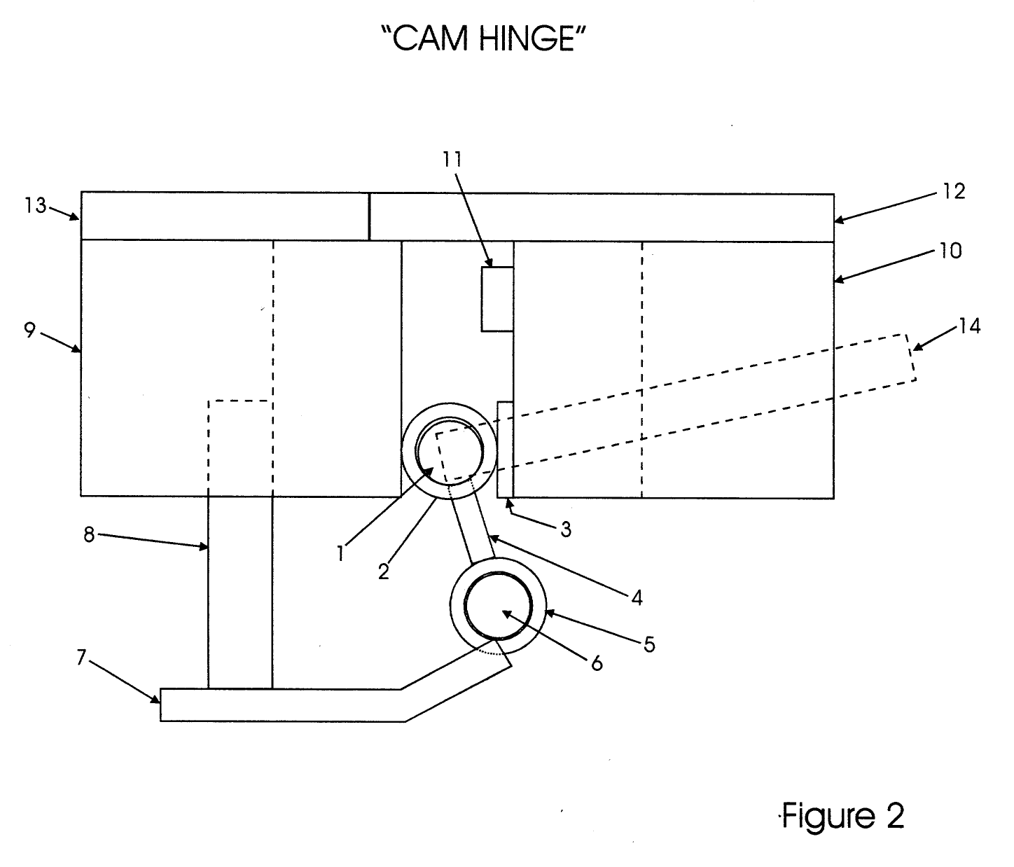

“In order for the Wing Framework 9 to be folded down and exert minimal stress on Single Cam Pivot Point 1,4,5 there is a Spacer 11 added for support which is welded to Main Frame 10. Once Wing Framework 9 is folded down to position, lever 14 or an equivalent device can assist in the rotation of Main Shaft 1, which allows the Wing floor 13 to join with the Main floor 12 and is best viewed in FIG. 2. It is for the fabricator to decide which method will be used for locking the two Frames 9 and 10 together.”

“In the embodiments of the invention it is not shown in any Figures that there is a support leg located on the outside edge of the Wing Framework 9 to provide support during setup and removal of the stage platform.”

What I claim as my invention is:

1 A Cam Hinge mechanism comprised of a Single Pivot Point, and a Single Cam Pivot Point, to allow two surfaces that are perpendicular to one another to be folded and create one larger surface in one plane.

2 A Cam Hinge mechanism in which the Single Cam Pivot Point,
has a horizontal positioned Shaft that runs full length of desired surface lengths
Bushings fastened to Framework of one surface to provide support for horizontal positioned Shaft and create pivot location
there is a Spacer attached perpendicular to the horizontally positioned Shaft
Bushing fastened horizontally to spacer, thus creating cam movement and location for Single Pivot Point Shaft

3 A Cam Hinge mechanism in which the Single Pivot Point,
has a horizontal positioned Shaft
Shaft may run full length of desired surface length, or short Shafts for each consecutive hinge
there is a Support Arm attached to Shaft
attached perpendicular from end of Support arm to location on folding surface frame, is a Connecting Arm

4 A Cam Hinge mechanism in which the Single Cam Pivot Point, must be rotated with the assistance of lever or similar device that may rotate Shaft.
